(19) United States
(12) Patent Application Publication
(10) Pub. No.: US 2010/0293829 A1
(43) Pub. Date: Nov. 25, 2010

(54) LABEL ASSEMBLY AND METHOD OF USE

(75) Inventors: Lynette M. Miles, Lakeville, MN (US); Andrew J. Callinan, Shoreview, MN (US); Eric W. Hemmesch, Woodbury, MN (US); Jon E. Stickrod, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/470,640

(22) Filed: May 22, 2009

(51) Int. Cl. G09F 3/10; G09F 3/02

(52) U.S. Cl. 40/638; 40/674

(57) ABSTRACT

A label assembly comprising a plurality of labels on a carrier sheet wherein the carrier sheet has a bisector line and a perimeter line as follows:
(1) the bisector line extends from a first edge of the carrier sheet to the opposing edge of the carrier sheet dividing the carrier sheet into substantially symmetric halves; and
(2) a perimeter line that is closed upon itself and intersects the bisector line at two locations,
dividing the carrier sheet into a frame portion and an array portion.

The bisector line and the perimeter line divide the array portion into two backing segments. Also a method using such label assembly comprising folding the assembly along the bisector line and separating the frame portion of the carrier sheet from the array portion of the carrier sheet along the perimeter line.

### FILED

The present invention relates to label assemblies. More particularly, the present invention relates to a design for label assemblies in which the labels may be easily individualized, sorted, and used.

### BACKGROUND

Self-adhesive labels are widely used for a variety of organizational and communication purposes. In general, they have a basic construction comprising a body or facestock with an adhesive on its back surface (sometimes referred to as label stock). The body may be a single ply or may be of multilayer construction. The front surface is typically adapted to receive a legend, e.g., via typing, handwriting, printing with a computer printer, etc. For instance, an image receptive layer may be provided on the front surface of the body to make it easier to place a desired legend or information thereon. Illustrative examples of materials used in the label body include paper, polymeric films, fabrics, etc. with the selection being dependent in part upon the performance properties desired of the resultant labels. Many different adhesives are known to be used in label constructions with selection being dependent in part upon such factors desired label performance, intended substrates, body properties, etc.

Many label assemblies (sometimes referred to as “label sheets”) currently sold in the marketplace contain die cut labels that can be removed from the label assembly either by peeling individual labels from a carrier sheet or liner or by individualizing the label assemblies into smaller label assemblies where each label remains adhesively attached to its liner. These individual labels are either offered on a label assembly with perforations that allow for separation or are already individualized.

Illustrative examples of some known label assemblies are disclosed in U.S. Pat. No. 6,803,084 (Do et al.), U.S. Pat. No. 6,837,957 (Flynn et al.), U.S. Pat. No. 6,860,050 (Flynn et al.), and U.S. Pat. No. 7,208,212 (Do et al.), and U.S. Appln. Publn. Nos. 2005/0089663 (Wong et al.), and 2009/0075010 (Flynn et al.).

Despite the many variations of known label constructions, the need exists for improved label constructions. For example, labels which provide high conspicuity and pleasing aesthetic appearances are desired for many applications.

### SUMMARY

The present invention provides a label assembly and method of using such an assembly to fabricate the labels in a quick, easy fashion with limited waste pieces and increased convenience. The design of label assemblies of the invention permits good printer feedability with a variety of printing devices and retains a printable margin for product information.

In brief summary, the label assembly of the invention comprises a carrier sheet as described herein having a front major surface and a back major surface and a plurality of labels releasably disposed on the front major surface of the carrier sheet. The carrier sheet has a bisector line and a perimeter line formed therein as follows:
(1) the bisector line extends from a first edge of the carrier sheet to the opposing edge of the carrier sheet such that the bisector line divides the carrier sheet into substantially symmetric halves; and
(2) a perimeter line that is closed upon itself, intersects the bisector line at two locations, does not intersect an edge of the carrier sheet, and divides the carrier sheet into a frame portion and an array portion.
   The bisector line and the perimeter line intersect so as to divide the array portion of the carrier sheet into two backing segments. At least that portion of the bisector line that lies between the two points at which it intersects the perimeter line is a weakened line of separation and is a line of symmetry to the array portion and to the outline of the perimeter line. The perimeter line is a weakened line of separation along substantially its entire length.

Briefly summarizing, the method of the invention comprises folding the assembly along the bisector line, optionally folding the assembly along a medial lateral line if it has one, and separating the frame portion of the carrier sheet from the array portion of the carrier sheet along the perimeter line.

Typically images can be printed on the front surfaces of label assemblies of the invention by hand, by printer, e.g., a laser printer or inkjet printer such as are commonly used with personal computers.

An advantage of the present invention is that the frame portion may be removed in a single piece for convenient disposal. Another advantage is that labels may be separated with individual array segments intact making them easier to sort, dispense, etc.

### BRIEF DESCRIPTION OF DRAWINGS

The present invention can be better explained with reference to the drawings, wherein:

FIG. 1 is a plan view of the front side of one embodiment of a label assembly of the invention;

FIG. 2 is a plan view of the rear side of the label assembly shown in FIG. 1;

FIG. 3 is a perspective view of the label assembly shown in FIG. 1 folded along the bisector line;

FIG. 4 is a perspective view of the label assembly shown in FIG. 3 further folded along the medial lateral line;

FIG. 5 is a perspective view of the label assembly shown in FIG. 4 after partial separation of the frame portion; and

FIG. 6 is a perspective view of the frame portion after removal from the array portion of the label assembly.

The drawings present the invention by way of representations and not limitation. Numerous other modifications and embodiments can be devised by one skilled in the art which fall within the scope and spirit of the principals of this invention. The figures are idealized, are not drawn to scale, and are intended merely for illustrative purposes.

### DETAILED DESCRIPTION OF ILLUSTRATIVE EMBODIMENTS

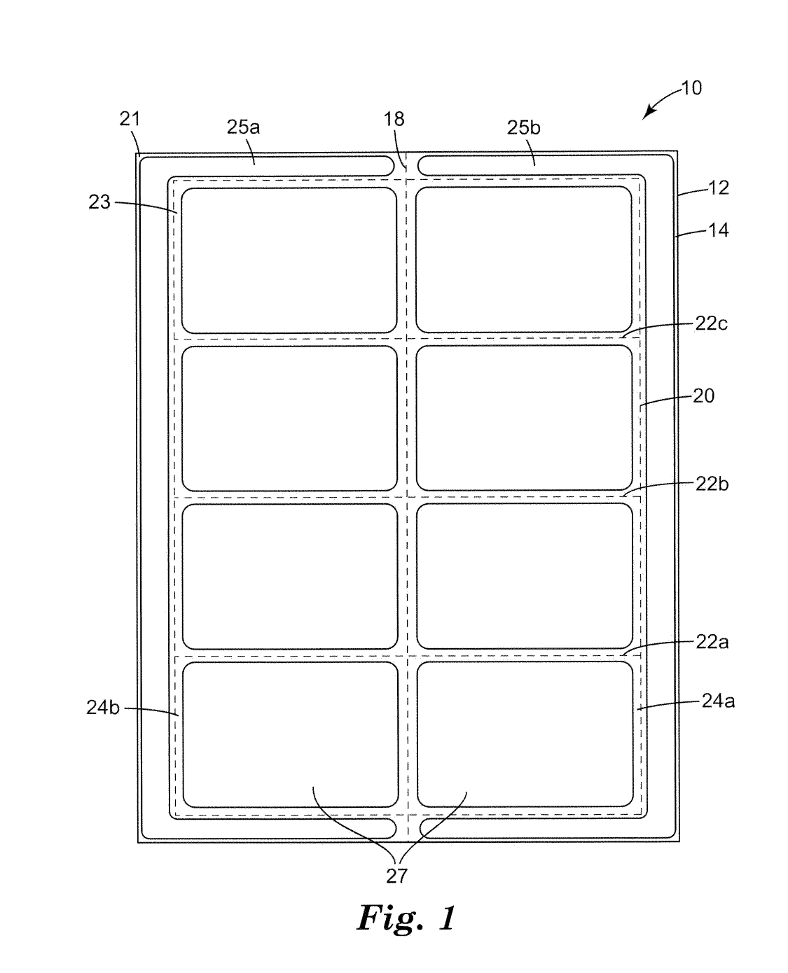

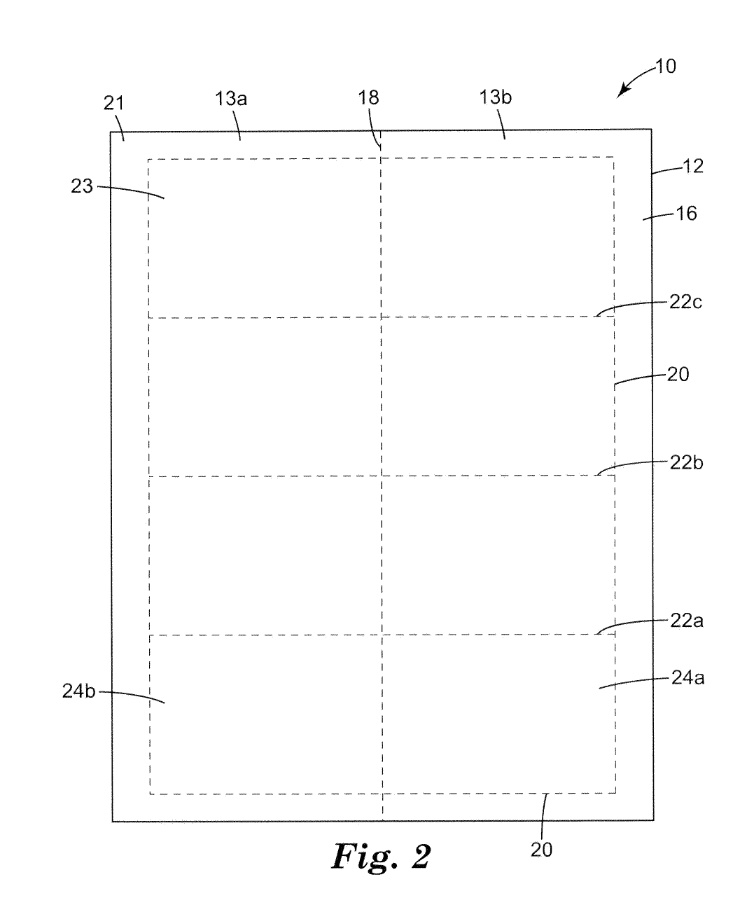

An illustrative label assembly of the invention is shown in FIGS. 1 and 2 wherein is shown the front and rear sides of label assembly 10.

Carrier sheet 12 has front major surface 14 and back major surface 16 and has bisector line 18 and perimeter line 20 formed therein.

Bisector line 18 extends from a first edge of carrier sheet 12 to the opposing edge of carrier sheet 12 such that it divides carrier sheet 12 into substantially symmetric halves 13a, 13b. At least that portion of bisector line 18 that lies between the two points at which it intersects perimeter line 20 is a weakened line of separation. That portion of the bisector line is also a line of symmetry to array portion 23 of carrier sheet 121 and to perimeter line 20. In other words, if assembly 10 is folded along bisector line 18, halves 13a and 13b will line up as mirror images of each other and the portion of perimeter line 20 in halve 13a will line up with the portion of perimeter line 20 in halve 13b.

Perimeter line 20 is closed upon itself, intersects bisector line 18 at two locations, does not intersect an edge of carrier sheet 12, and defines frame portion 21 and array portion 23 of carrier sheet 12. Perimeter line 20 is a weakened line of separation along substantially its entire length.

Typically, the label assembly will further comprise at least one optional lateral line that intersects the perimeter line at least once, that intersects the bisector line once, and that is substantially perpendicular to the bisector line. FIGS. 1 and 2 show medial lateral line 22b that is located substantially equidistantly from opposing ends of said assembly and intersects said perimeter line twice. Medial lateral line 22b is a weakened line of separation along substantially its entire portion located within array portion 23. If desired, medial lateral line 22b may extend beyond perimeter line 20 into frame portion 21, optionally to one or both edges of carrier sheet 12.

In some embodiments, the label assembly will further comprise one or more lateral lines, e.g., 22a, 22c, that each intersect perimeter line 20 at least once, intersect bisector 18 once, and are parallel to medial lateral line 22b. Each such lateral line is a weakened line of separation along substantially its entire portion located within array portion 23. If desired, one or more of the lateral lines may extend beyond perimeter line 20 into frame portion 21, optionally to one or both edges of carrier sheet 12. Such lateral lines may be formed in only one halve of the array portion or may extend all the way across the array portion from one intersection with the perimeter line across the array portion and intersection with the bisector line to a second intersection with the perimeter line. Array portion 23 is divided into two or more array segments by perimeter line 20, bisector line 18, and the lateral lines (if any).

A plurality of labels 27 are releasably disposed on front major surface 14 of carrier sheet 12 in array portion 23. The labels are disposed in the array portion of the carrier sheet, typically with one label per each array segment though embodiments with more than one label per segment may be made in accordance with the present invention.

The front face of the label stock desirably has a printable surface. By the phrase “printable surface” is meant a surface of any type of matter upon which a person or machine can draw, print, color, paint, photocopy, write, emboss, or make any other type of mark or graphic. Laser printers, ink jet printers, impact printers, thermal transfer printers, direct thermal printers, typewriters, or any other suitable graphic printing devices are preferred but not necessary for use with printable surfaces according to this invention.

The label stock is preferably, but not necessarily, constructed of any suitable paper, paper composite, plastic, fabric, non-metal, and/or metal sheet material that can be used as a label. Selection of suitable materials will be dependent in part upon the desired application including such factors as desired color, moisture stability, flexibility, elongation, elasticity, receptivity to imaging materials, etc.

Those skilled in the art will be able to readily select appropriate label stock materials for desired applications.

The adhesive permits the label to be adhered to an adherend. In many embodiments, the adhesive will be pressure sensitive though depending upon the labeling performance desired activated adhesives may be used if desired. Repositionable, removable, and permanent bonding adhesives may be used as desired. If a light transmissive adhesive is used, the color(s) of the substrate to which the label is applied will provide special effect through the label, e.g., if the labels are used as name tags the labels on persons wearing different colored clothing will have unique appearances. If desired, one or more colorants such as pigments and dyes may be incorporated into the adhesive layer to impart desired appearance to the resultant labels.

Suitable adhesives for selected labeling applications can be readily selected by those skilled in the art.

Suitable release liners may also be readily selected by those skilled in the art. The selection will be dependent in party upon such factors as properties of the adhesive, conditions under which the labels will stored, used, and applied.

The perimeter line and portions of the bisector line and, if any, portions of the lateral lines represent lines of structural weakening in the carrier sheet providing locations at which it can be readily folded and separated as discussed herein. Each tearable line or line of weakening, according to this invention, comprises, for example, at least one of a die cut line, a kiss cut line (which is a die cut line that does not extend completely through a layer or sheet), a laser die cut line, a score cut line, a perforation line, a microperforation line, a chemically etched line, a liquid etched line and/or a gas etched line. In instances where the bisector line or lateral line(s), if any, intersect the frame, the line of structural weakening may or may not be formed in the frame as desired, provided that the frame can be folded as described herein.

In many embodiments, the array portions of the carrier sheet are substantially rectangular in shape and the side portions of the perimeter line are substantially parallel to the bisector line. If desired, however, the carrier portion and perimeter line may be of other configurations, provided that the bisector is a line of symmetry to the array portion. A line of symmetry is a line that divides a figure or shape into two mirror images. A simple test to determine if a figure has line symmetry is to fold the figure along the supposed line of symmetry and see if the two halves of the figure coincide, if so then the fold line is a line of symmetry. The perimeter line may be made up of straight segments separated by sharp, relatively non-radiused corners as shown in the figures, or may comprise one or more curved segments and/or one or more radiused corners if desired, provided that the array zone is substantially symmetrical about the bisector line. The lateral lines may be straight as shown or may be curved if desired.

As shown in FIG. 1, label assembly 10 may optionally further comprise at least one frame 25a, 25b disposed on the frame portion 16 of carrier sheet 12, e.g., portions of label stock. Such frames provide increased thickness and stiffness to the label assembly 12, e.g., making it easier to pass through a printer effectively. Such frames may also be used to reduce the tendency of carrier sheets to curl, e.g., upon exposure to varying temperatures and humidity, etc. Also, they provide a convenient location on which to include user information, e.g., template number, inventory information, etc. on the label assembly. In order to facilitate folding of assembly 10 as described below, it is typically preferred that the frame(s) do not overlie bisector line 18. The frame 25a, 25b may overlie bisector line 18 provided that the assembly can be folded, for instance, in such instances it may be preferable to form fold lines in the frame material, e.g., by forming a weakened line therein, as will be readily understood by those skilled in the art.

The labels may be substantially coextensive with the array segments on which they reside. Alternatively, the labels may be inset from one or more of the edges of the array segment on which they reside, i.e., they do not abut nor overlay any of the weakened lines of separation that define the boundaries of the array segment.

Typically, the carrier sheet is rectangular in shape, although carrier sheets having other configurations may be used in accordance with the present invention.

In many embodiments, label assemblies of the invention will be made by laminating a sheet of label stock (i.e., face stock with adhesive) to the front surface of a sheet of the carrier material then die cutting and removing weed to leave the labels and frame(s), if any, on the carrier sheet. Die cutting and weeding are typically more easily carried out of the corners of the labels and frame(s) have radiused, i.e., rounded, scorners, though embodiments with non-radiused corners may be formed if desired. The sides of the labels, frame(s) may be substantially straight as shown in the figures or may be curved if desired.

In use, a label assembly of the invention is used as follows.

First, images may optionally be formed on one or more the labels, e.g., by passing the assembly through a computer printer, by hand, adhesion of a decal, etc.

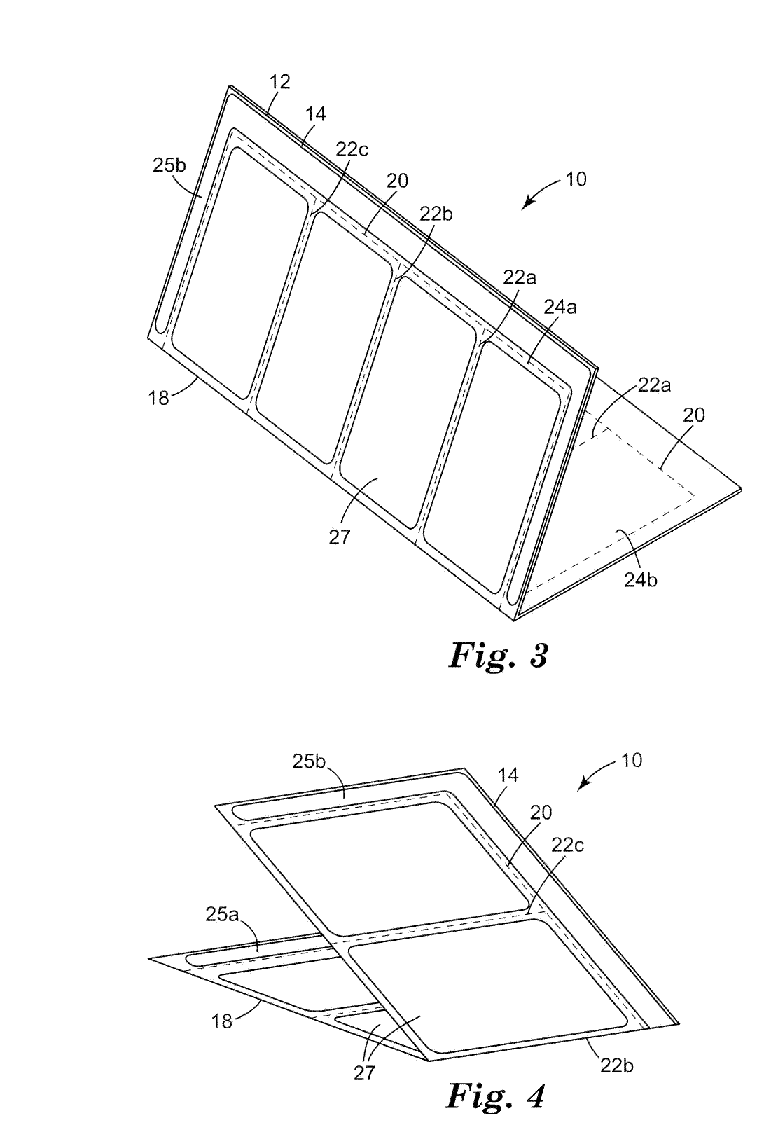

Next, the assembly is folded in half along the bisector line 18 as shown in FIG. 3. The assembly may be folded with the labels facing outward as shown in FIG. 3 or with the labels facing inwardly as desired. Because bisector line 18 is a line of symmetry to array portion 23, folding in this manner aligns the portions of perimeter line 20 in each half with the corresponding portions in the other half of the array.

The matrix or frame portion 21 of the carrier sheet may be separated from the array portion 23 at this time. This is typically carried out by flexing at the perimeter line and then tearing, alternatively, if the perimeter line is weak enough, simply tearing will be sufficient. The removed frame portion is in a “C” shaped segment.

Alternatively, before removal of the frame portion 21, the assembly 10 may be further folded along medial lateral line 22b as shown in FIG. 4. Following this action, the perimeter line is configured in an overlapping “L”.

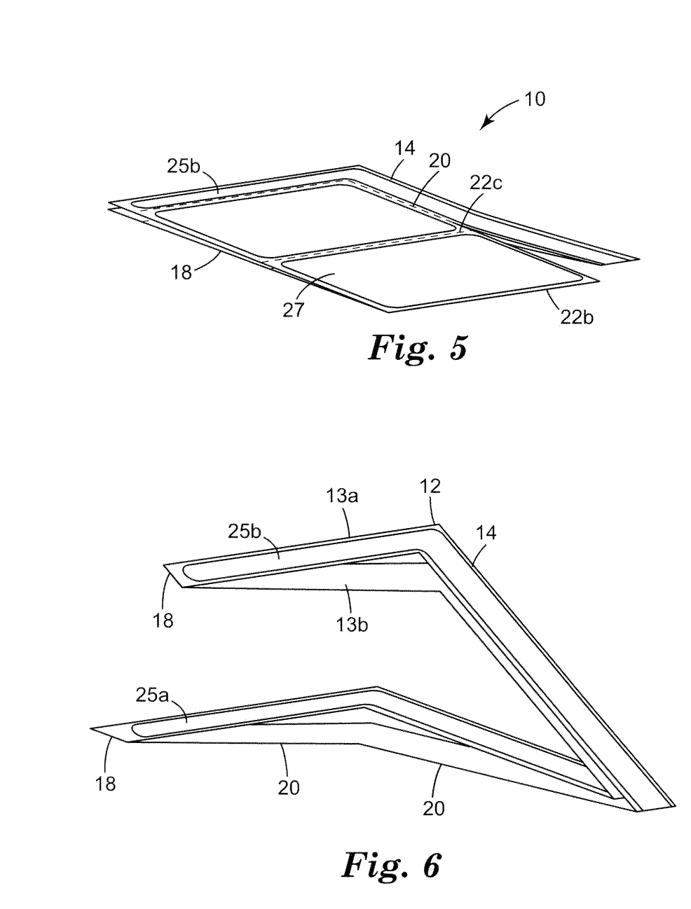

Next, the matrix or frame portion 21 of the carrier is removed from the array portion 23 by separating at the perimeter line 20 as shown in FIG. 5. This is typically carried out by flexing at the perimeter line and then tearing, alternatively, if the perimeter line is weak enough, simply tearing will be sufficient.

At this point, the frame portion 21 can be removed in a single piece as shown in FIG. 6, making it easier to remove and to dispose of.

Following removal of the frame portion, the remaining portion of the label assembly, i.e., the array portion of the carrier with labels thereon, may then be separated at the bisector line and lateral line(s), if any, into individual array segments with labels thereon that can be conveniently sorted, arrayed, transported, etc.

Typically it is preferable that at least a portion of the carrier extends beyond the perimeter of each label, i.e., that the edge of each individual label does not abut all sides of its individual carrier, to facilitate removal of the label from the carrier.

Label assemblies of the invention are typically configured for printing with conventional inkjet and/or laserjet printers. Commonly known configurations include sheets that are 8.5×5.5 inches, American standard letter size (i.e., 8½×11 inches or 216×279 mm in dimension), legal size (8.5 by 14 inches), and A4 (i.e., 210×297 mm in dimension). The label assembly is of any suitable shape, and generally any suitable size that can be accepted by and fed through a printer, such as a laser printer or an ink jet printer.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

This description of the invention refers to several patents, each of which is incorporated herein by reference in its entirety.

1. A label assembly comprising:
(a) a carrier sheet having a front major surface and a back major surface, said carrier sheet having a bisector line and a perimeter line formed therein as follows:
(1) said bisector line extending from a first edge of said carrier sheet to the opposing edge of said carrier sheet such that it divides said carrier sheet into substantially symmetric halves; and
(2) a perimeter line that is closed upon itself, intersects said bisector line at two locations, does not intersect an edge of said carrier sheet, and divides said carrier sheet into a frame portion and an array portion;
wherein said bisector line and said perimeter line intersect so as to divide said array portion of said carrier sheet into two backing segments, wherein at least that portion of said bisector line that lies between the two points at which it intersects said perimeter line is a weakened line of separation, wherein at least that portion of said bisector line that lies between the two points at which it intersects said perimeter line is a line of symmetry to said array portion and to said perimeter line, and wherein said perimeter line is a weakened line of separation along substantially its entire length; and
(b) a plurality of labels releasably disposed on said front major surface of said carrier sheet.

2. The label assembly of claim 1 wherein said carrier sheet has at least one additional weakened line of separation as follows:
(3) a lateral line that intersects said perimeter line at least once and said bisector line once, and is substantially perpendicular to said bisector line.

3. The label assembly of claim 2 wherein said lateral line is a medial lateral line that is located substantially equidistantly from opposing ends of said assembly and intersects said perimeter line twice.

4. The label assembly of claim 3 wherein said carrier sheet has one or more additional weakened lines of separation as follows:
(4) one or more lateral lines that each intersect said perimeter line at least once, intersect said bisector once, and are parallel to said medial lateral line.

5. The label assembly of claim 4 wherein said additional weakened lines of separation intersect said perimeter line twice.

6. The label assembly of claim 1 wherein said array portion of said carrier sheet is substantially rectangular in shape and the side portions of said perimeter line are substantially parallel to said bisector line.

7. The label assembly of claim 1 further comprising at least one frame disposed on said frame portion of said carrier sheet.

8. The label assembly of claim 1 wherein said labels do not abut nor overlay any of said weakened lines of separation.

9. The label assembly of claim 1 wherein said labels comprise a face member and an underlying layer of adhesive.

10. The label assembly of claim 1 wherein said carrier sheet is substantially rectangular in shape.

11. The label assembly of claim 1 wherein said assembly has a configuration selected from the group consisting of standard letter format and A4 format.

12. A method for using the label assembly of claim 3 comprising folding said assembly along said bisector line, folding said assembly along said medial lateral line, and separating said frame portion of said carrier sheet from said array portion of said carrier sheet along said perimeter line.

13. The method of claim 12 wherein said frame portion of said carrier sheet is removed as a single member.

14. The method of claim 12 wherein separating said frame portion and said array portion comprises flexing at least a portion of said perimeter line.

15. The method of claim 12 further comprising separating said array portion at said bisector line.

16. The method of claim 12 wherein carrier sheet has one or more lateral lines and said method further comprises separating said assembly along one or more of said lateral lines.

17. The method of claim 12 further comprising forming an image on one or more of the front faces of said labels.
